(19) United States
(12) Patent Application Publication
(10) Pub. No.: US 2005/0089346 A1
(43) Pub. Date: Apr. 28, 2005

(54) Spaced biased roll charging member having clipped AC input voltage

(75) Inventor: Michael F. Zona, Holley, NY (US)

Correspondence Address: PATENT DOCUMENTATION CENTER, XEROX CORPORATION, 100 CLINTON AVE., SOUTH, XEROX SQUARE, 20TH FLOOR, ROCHESTER, NY, 14644, US

(73) Assignee: Xerox Corporation

(21) Appl. No.: 10/696,160

(22) Filed: Oct. 28, 2003

(51) Int. Cl. G03G 15/02

(52) U.S. Cl. 399/168

(57) ABSTRACT

An apparatus for applying an electrical charge to a member to be charged, including a contact roll member situated spaced from a surface of the member to be charged, and means for applying an electrical bias to the contact roll member, the electrical bias including an oscillating voltage signal which is clipped to remove a selected polarity component thereof to supply a single polarity oscillating input drive voltage to the contact roll member.

### BACKGROUND

The present invention relates generally to an apparatus for generating a substantially uniform charge on a surface, and, more particularly, concerns a biased roll charging apparatus having a clipped AC input voltage being spaced from an imaging member, primarily for use in electrostatographic applications. For example, to charge an imaging member such as a photoreceptor.

Generally, the process of electrostatographic reproduction is initiated by substantially uniformly charging a photoreceptive member, followed by exposing a light image of an original document thereon. Exposing the charged photoreceptive member to a light image discharges a photoconductive surface layer in areas corresponding to non-image areas in the original document while maintaining the charge on image areas for creating an electrostatic latent image of the original document on the photoreceptive member. This latent image is subsequently developed into a visible image by a process in which a charged developing material is deposited onto the photoconductive surface layer, such that the developing material is attracted to the charged image areas on the photoreceptive member. Thereafter, the developing material is transferred from the photoreceptive member to a copy sheet or some other image support substrate to which the image may be permanently affixed for producing a reproduction of the original document. In a final step in the process, the photoconductive surface layer of the photoreceptive member is cleaned to remove any residual developing material therefrom in preparation for successive imaging cycles.

The described electrostatographic reproduction process is well known and is useful for light lens copying from an original, as well as for printing applications involving electronically generated or stored originals. Analogous processes also exist in other printing applications such as, for example, digital laser printing where a latent image is formed on the photoconductive surface via a modulated laser beam where charge is removed from a charged photoconductive surface in response to electronically generated or stored images. Some of these printing processes develop toner on the discharged area, known as DAD, or “write black” systems, in contradiction to the light lens generated image systems which develop toner on the charged areas, known as CAD, or “write white” systems. The subject invention applies to both DAD or CAD systems.

Bias charge roll (BCR) charging systems have been used in machines to apply a uniform background potential in DAD xerographic systems. As the market moves to faster color machines, contact-charging methods exhibit two severe shortfalls. The first is related to contamination from toner and toner additive particles building up on the charge roll and causing non-uniform charge. The second is the drastic increase in wear of the photoconductive surface layer. To avoid these shortfalls, most have implemented non-contact (scorotron) charging exhibiting high ozone and NOx generation, or spent additional cost on elaborate cleaning devices for the charge roll itself and overcoat technology for the photoreceptors.

These and other aspects of the present invention will become apparent from the following description in conjunction with the accompanying drawings in which:

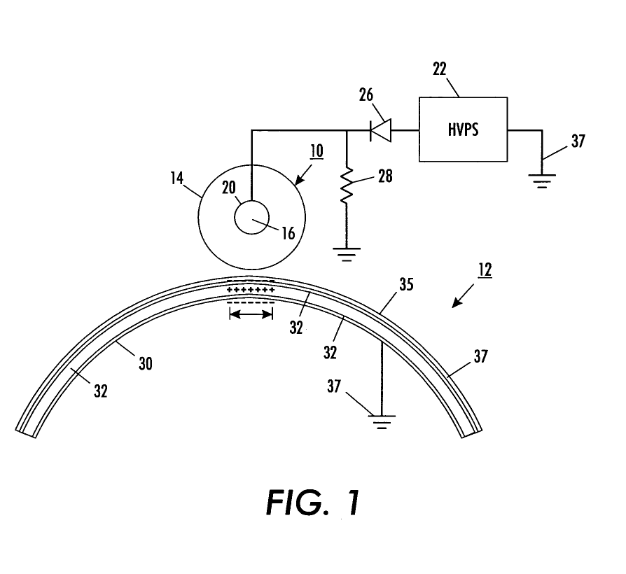

FIG. 1 is a partial schematic view of a biased roll charging system in accordance with the present invention and showing the electrostatic operation of the system;

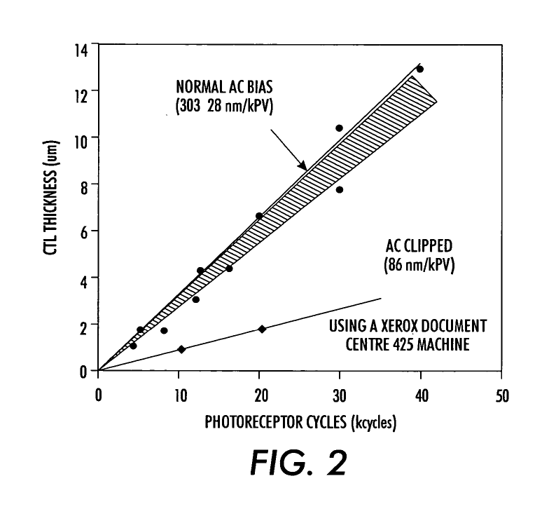

FIG. 2 is a graphical representation improvement in wear that can be achieved by the bias roll charging system of the present invention relative to a conventional bias charge roll charging system using a non-clipped oscillating input voltage signal.

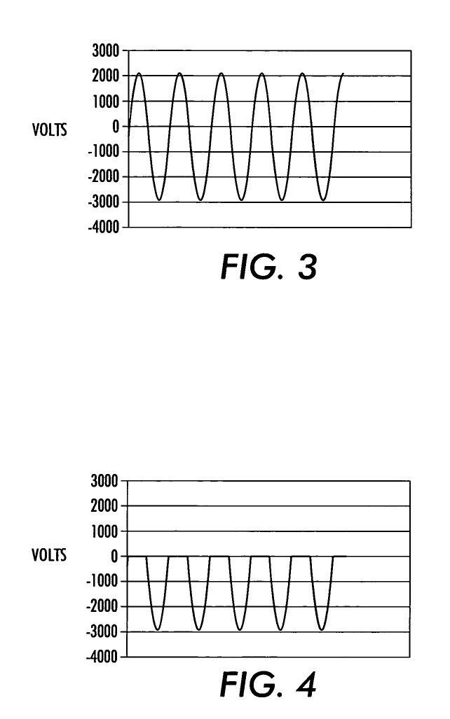

FIG. 3 is a graphical representation of the non-clipped AC input voltage applied to the charging apparatus of the typical prior art; and

FIG. 4 is a graphical representation of the clipped AC input voltage applied to the charging apparatus of the present invention; and

For a general understanding of the features of the present invention, reference is made to the drawings wherein like reference numerals have been used throughout to designate identical elements. While the present invention will be described in connection with a preferred embodiment thereof, it will be understood that the invention is not limited to this preferred embodiment. On the contrary, the present invention is intended to cover all alternatives, modifications, and equivalents as may be included within the spirit and scope of the invention as defined by the appended claims.

In particular, it will be recognized, that while the present invention describes a charging system for a typical electrostatographic application, the instant charging structure is equally well suited for use in a wide variety of other electrostatographic-type processing machines and is not necessarily limited in its application to the particular embodiment or embodiments shown herein. In particular, it should be noted that the charging apparatus of the present invention, described hereinafter with reference to an exemplary charging system, may also be used in a transfer, detack, or cleaning subsystem of a typical electrostatographic apparatus since such subsystems may also require the use of a charging device. In addition, it will be recognized that the biased roll charging system may have equal application for applying an electrical charge to a member other than a photoreceptor and/or in environments outside the realm of electrostatographic printing.

Referring initially to FIG. 1, a biased roll charging system in accordance with the present invention is shown in the context of an exemplary electrostatographic reproducing apparatus, employing a photoreceptor member or drum 12 including a photoconductive surface 35 deposited on an electrically grounded conductive substrate 38. A motor (not shown) engages with drum 12 for rotating the drum 12 to advance successive portions of photoconductive surface 35 through various processing stations disposed about the path of movement thereof, as is well known in the art. Initially, a portion of drum 12 passes through a charging station where a charging device in accordance with the present invention, indicated generally by reference numeral 10, charges the photoconductive surface on drum 12 to a relatively high, substantially uniform potential.

Referring now, more particularly, to the bias roll charging system 10, a conductive roll member 14 is spaced from the photoreceptor member 12 having an air gap of 20 to 50 microns therefrom. The conductive roll member 14 is axially supported on a conductive core or shaft 20, situated transverse to the direction of relative movement of the photoreceptor member 12. In a preferred embodiment, the conductive roll member 14 is provided in the form of a deformable, elongated roller supported for rotation about an axis 16 and is preferably comprised of a polymer material such as, for example, Neoprene, E.P.D.M. rubber, Hypalon rubber, Nitrile rubber, Polyurethane rubber (polyester type), Polyurethane rubber (polyether type), Silicone rubber, Viton/Fluorel rubber, Epichlorohydrin rubber, or other similar materials having a D.C. volume resistivity in the range of 10³ to 10⁷ ohm-cm after suitable compounding with carbon particles, graphite or other conductive additives. These materials are chosen for their ease in manufacturability and compoundability, as well as wearability and economy.

A high voltage power supply 22 is connected to conductive roll member 14 via shaft 20 for supplying an oscillating input drive voltage to the roll member 14. The oscillating input drive voltage is selected to have a peak-to-peak voltage based on the desired charge potential to be induced on the photoreceptor surface. While it is possible to use a standard line voltage, other voltage levels or voltage signal frequencies may be desirable in accordance with other limiting factors dependent on individual machine design, such as the desired charge level to be induced on the photoreceptor, or the speed of copying and printing operations desired.

With particular regard to biased roll charging, a suitable photoreceptor member 12 has the property of injecting a single sign of mobile carriers from a charge generating layer into a charge transport layer such that a surface charge potential having only a single charge polarity is generated on the surface of the photoreceptor member 12, irrespective of the inducing voltage signal applied to roll member 14. With reference to FIG. 1, the photoconductor member 12 generally includes a grounded conductive substrate 38, such as an aluminum sheet connected to a ground potential 37, a charge generating layer 30, comprising a material such as gold or trigonal selenium, a charge transport layer 32 comprising a photoconductive insulator, such as selenium or its alloys overlayed thereon, and a dielectric overcoating 34, forming the outer surface 35 of the photoreceptor member 12.

The charging operation involves the application of the A.C. voltage signal from the bias charging system 10 to the photoconductive surface of photoreceptor member 12, which creates a voltage potential across the photoreceptor to ground 37. Charge carriers from the charge generating layer 32 migrate into the bulk of the charge transport layer 32 the upper surface 36 of the photoconductive material, where the charge will be trapped. The thin dielectric overcoating 34 is desirable on either the conductive roll member 14 or the photoreceptor member 12 for a variety of reasons, including protection of the surfaces of conductive roll member 14 or photoreceptor member 12, or for a current limiting action which may allow the use of low resistivity rollers, or for photoreceptor or roll member surface property control. In the embodiment shown in the drawings, overcoating 34 is provided on the upper surface of the photoreceptor. Alternatively, an overcoating may be provided on the outer surface of bias conductive roll member 14 for the same effect.

In a specific embodiment of the present invention, a simple diode/resistor circuit 26, 28 is coupled to the high voltage power supply 22 for eliminating the positive component of the DC offset AC waveform provided thereby. This diode/resistor circuit acts as a rectifier circuit for eliminating or clipping the positive component of the oscillating AC voltage signal. In an exemplary embodiment, a typical bias charge roll input drive voltage having a peak-to-peak voltage of 1.6 kilovolts with a DC offset of minus 350 volts at a frequency of 400 hertz will result in 450 volts of positive charge and 1150 volts of negative charge for delivering a photoreceptor surface potential of approximately minus 330 volts. By clipping the positive component of this typical AC input waveform, as shown in FIG. 4, this typical AC input voltage signal can increase the surface potential on the same photoreceptor to approximately 530 volts. Thus, by eliminating an unused component of the oscillating input voltage signal, current requirements of the bias charge roll system necessary to achieve required negative photoreceptor surface potentials can be significantly reduced. A negative surface charge potential is provided through the use of a negative input potential at the bias charge roll 14, thereby eliminating excessive current flow to the surface of the photoreceptor which accelerates the degradation and wear of the charge transport layer thereof.

In contact type roll charging, any uncleaned toner or, more often, toner additives, get impacted into the surface of the BCR in the nip formed between it and the photoreceptor surface. Depending on the materials and the environmental conditions, this contamination can cause severe non-uniform charging. To overcome this problem, various configurations of cleaning technologies have been employed to clean the BCR surface. Because the materials are well impacted into the surface, very rough and abrasive cleaning must take place to clean the roll successfully, thereby shortening the life of the charging subsystem and increasing the cost of the charge cleaning system. In the non-contact system as described, the contamination is still present, but it does not impact into the surface of the BCR surface due to the 20-50 micron air gap between the charge roll surface and the photoreceptor surface. This allows for a very mild cleaning technique to keep the surface of the roll clean. In typical non-contact methods using a non-clipped AC voltage as shown in FIG. 3, higher AC voltage is required to charge uniformly over the 20-50 micron gap causing the wear of the transport layer to become the life limiting factor in the xerographic system. To overcome this issue, others practiced in the art use a robust overcoat on the surface of the photoreceptor to increase life. The applicant has found that robust overcoats can lead to other subsystem interactions that must be overcome, mostly related to cleaning/filming. However, the present invention wear is substantially reduce through clipping of the positive portion of the AC voltage so that robust overcoats are not required.

With reference to FIG. 2, it can be seen that improve wear prevention can be achieved over a conventional bias charge roll charging system using a non-clipped oscillating input voltage signal. By eliminating the positive portion of the BCR voltage, the wear of the transport layer is significantly reduced. The amount of wear was reduced by a factor of three and a half. CTL surface scanning electron micrographs indicated much smoother wear profiles using the clipped AC technique over the standard full sine wave.

It is, therefore, apparent that there has been provided, in accordance with the present invention, a biased roll charging device that fully satisfies the aims and advantages set forth hereinabove. While this invention has been described in conjunction with a specific embodiment thereof, it will be evident to those skilled in the art that many alternatives, modifications, and variations are possible to achieve the desired results. Accordingly, the present invention is intended to embrace all such alternatives, modifications, and variations which may fall within the spirit and scope of the following claims.

1. An apparatus for applying an electrical charge to a member to be charged, comprising:
a contact roll member situated spaced from a surface of the member to be charged; and
means for applying an electrical bias to said contact roll member, the electrical bias including an oscillating voltage signal which is clipped to remove a selected polarity component thereof to supply a single polarity oscillating input drive voltage to said contact roll member.

2. The apparatus of claim 1, wherein the electrical bias applying means includes means for applying a DC offset to the oscillating voltage signal.

3. The apparatus of claim 1, wherein the electrical bias applying means includes:
a high voltage power supply for providing a DC offset AC voltage signal;
a diode element coupled to the high voltage power supply for preventing current flow associated with a positive component of the DC offset AC voltage signal; and
a resistor element coupled between the diode element and a ground point for allowing current flow associated with a positive component of the DC offset AC voltage signal to flow to ground.

4. The apparatus of claim 3, wherein the high voltage power supply provides at least a 1.6 Kvolt AC voltage signal at a frequency of 400 to 3000 Hz and a DC offset of between −350 and −800 volts.

5. The apparatus of claim 1, wherein the electrical bias applying means includes:
a high voltage power supply for providing a DC offset AC voltage signal; and
a rectifier circuit for preventing current flow associated with a positive component of the DC offset AC voltage signal.

6. The apparatus of claim 1, wherein the member to be charged is a photoreceptive member having a photoconductive surface layer.

7. The apparatus of claim 1, wherein the oscillating voltage signal is in the form of a sinusoidal waveform.

8. The apparatus of claim 1, wherein charging device is spaced 20 to 50 microns from the imaging surface.
